(19) United States
(12) Patent Application Publication
(10) Pub. No.: US 2023/0272823 A1
(43) Pub. Date: Aug. 31, 2023

(54) UNIVERSAL JOINT AND PROPELLER SHAFT

(71) Applicant: Hitachi Astemo, Ltd., Hitachinaka-shi, Ibaraki (JP)

(72) Inventors: Noriyuki ONIHASHI, Hitachinaka-shi, Ibaraki (JP); Hidekazu AOKI, Hitachinaka-shi, Ibaraki (JP); Kenichiro ISHIKURA, Hitachinaka-shi, Ibaraki (JP)

(73) Assignee: Hitachi Astemo, Ltd., Hitachinaka-shi, Ibaraki (JP)

(21) Appl. No.: 18/043,698

(22) PCT Filed: Sep. 15, 2021
(86) PCT No.: PCT/JP2021/033849

§ 371 Date: Mar. 1, 2023

(30) Foreign Application Priority Data
Sep. 18, 2020 (JP) 2020-156829

(51) Int. Cl. F16D 3/41

(52) U.S. Cl. CPC F16D 3/41; F16D 2300/06

(57) ABSTRACT

A universal joint includes: a yoke; cups; a cross shaft; a plurality of needles; washers each including; a washer main body portion which has a circular plate shape, and which is disposed between one of the cup bottom portions, and one of the shaft portions, a needle side raised portion which has an annular shape, which is integrally formed on an outer circumference side of one of the washer main body portion, and which protrudes toward the needle side, and a cup bottom portion side raised portion which has an annular shape, which is integrally formed on the outer circumference side of the one of the washer main body portions, and which protrudes toward the cup bottom portion side.

### TECHNICAL FIELD

This invention relates to a universal joint and a propeller shaft.

### BACKGROUND ART

There has been known one example of a conventional universal joint described in, for example, a patent document 1.

This universal joint includes a cross shaft; and a pair of yokes pivotally connected with each other through the cross shaft. Each of the yokes includes a pair of arm portions radially confronting each other. The cross shaft is pivotally supported on the arm portions of the yokes through needle bearings. Each of the needle bearings includes a bottomed cylindrical cup which receives a shaft portion of the cross shaft, and which serves as an outer wheel; a plurality of needles which are provided between an inner circumference surface of the cup, and an outer circumference surface of the shaft portion of the cross shaft, and which serves as rolling members; and a washer which is provided between a bottom portion of the cup, and a tip end of the shaft portion of the cross shaft, and which has a two split (divided) shape having an inner circumference side and an outer circumference side in a radial direction.

### PRIOR ART DOCUMENT

### Patent Document

Patent Document 1: U.S. Patent No. 005,865,678

### SUMMARY OF THE INVENTION

### Problems which The Invention Is Intended to Solve

However, this conventional universal joint has the two split (divided) shape. Accordingly, the assembly workability is not favorable. A manufacturing cost of the universal joint is increased. There is room for the improvement.

It is, therefore, an object of the present invention to provide a universal joint and a propeller shaft which are devised to solve the above-described problems of the conventional universal joint, and to improve the assembly workability.

### Means for Solving The Problem

According to one aspect of the present invention, a washer includes a washer main body portion which is disposed between a cup bottom portion, and a tip end of one of shaft portions of a cross shaft; a needle side raised portion which is integrally formed on an outer circumference side of the washer main body portion, and which protrudes toward a needle side; and a cup bottom portion side raised portion which is integrally formed on the outer circumference side of the washer main body portion, and which protrudes toward the cup bottom portion side.

### Benefit of The Invention

In the present invention, it is possible to improve the assembly workability.

### BRIEF DESCRIPTION OF DRAWINGS

FIG. 1 is a perspective view of a propeller shaft according to the present invention.

FIG. 2 is an exploded perspective view showing the universal joint according to a first embodiment of the present invention.

FIG. 3 is a sectional view taken along a section line A-A of FIG. 2.

FIG. 4 is a sectional perspective view of the needle bearing shown in FIG. 3.

FIG. 5(a) is a perspective view of the cup. FIG. 5(b) is a plan view of the cup.

FIG. 6 is an enlarged view of a B portion in FIG. 3.

FIG. 7(a) is a plan view of a washer. FIG. 7(b) is a back view of the washer.

FIG. 8(a) is a sectional perspective view taken along a section line C-C of FIG. 7(a). FIG. 8(b) is a sectional view taken along a section line C-C of FIG. 7(a).

FIG. 9 show another example of the washer shown in FIG. 7. FIG. 9(a) is a plan view of the washer. FIG. 9(b) is a back view of the washer. FIG. 9(c) is a sectional view taken along a section line D-D of FIG. 9(a).

FIG. 10 show a variation of the first embodiment of the present invention. FIG. 10(a) is a plan view of the washer. FIG. 10(b) is a back view of the washer. FIG. 10(c) is a sectional view taken along a section line E-E of FIG. 10(a).

FIG. 11 show another example of the washer shown in FIG. 10. FIG. 11(a) is a plan view of the washer. FIG. 11(b) is a back view of the washer. FIG. 11(c) is a sectional view taken along a section line F-F of FIG. 11(a).

FIG. 12 is an exploded perspective view showing a universal joint according to a second embodiment of the present invention.

FIG. 13 is a sectional view taken along a section line G-G of FIG. 12.

### DESCRIPTION OF EMBODIMENTS

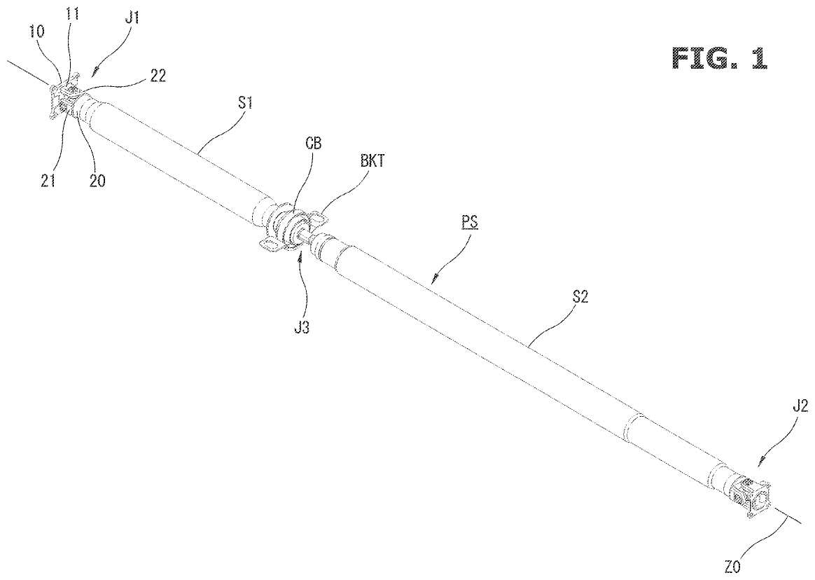

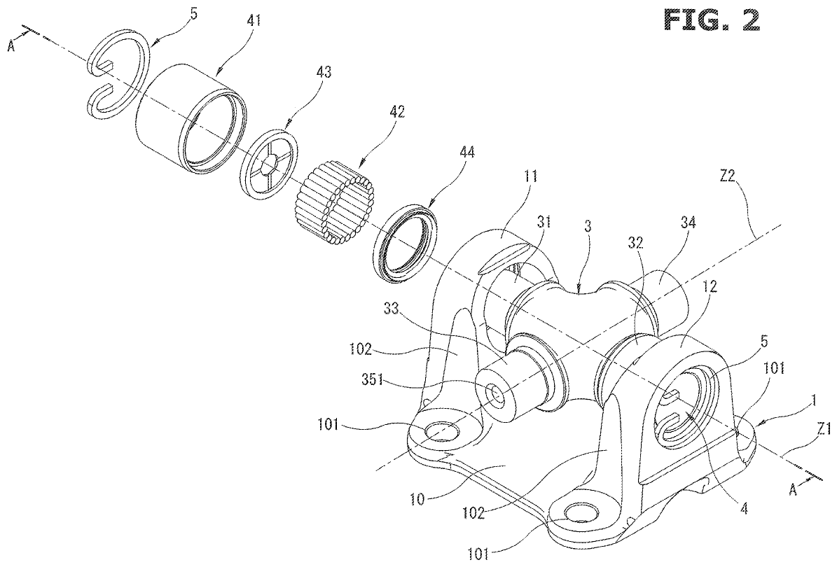

Hereinafter, universal joints and propeller shafts according to embodiments of the present invention are explained in detail with reference to the drawings. Hereinafter, for the explanations, a left side in FIG. 1 is defined as “front”. A right side in FIG. 1 is defined as “rear”. A direction along a rotation axis Z0 in FIG. 1 is defined as an “axial direction”. A direction perpendicular to the rotation axis Z0 are defined as a “radial direction”. A direction around the rotation axis Z0 is defined as a “circumferential direction”. Moreover, in FIG. 2 to FIG. 13, directions which are extending directions of the first to fourth shaft portions 31 to 34 of the cross shaft 3, and which are directions along the rotation axes Z1 and Z2 are defined as “axial directions”. Directions which are perpendicular to the first to fourth shaft portions 31 to 34 of the cross shaft 3, and which are perpendicular to the rotation axes Z1 and Z2 are defined as “radial directions”. Directions around the rotation axes Z1 and Z2 are defined as “circumferential directions”.

### Configuration of Propeller Shaft

FIG. 1 is a perspective view showing an outer appearance of a propeller shaft PS according to the present invention.

As shown in FIG. 1, the propeller shaft PS is disposed along a forward and rearward direction of the vehicle, between a first rotation shaft (not shown) which is a rotation shaft disposed on the front side of the vehicle, and a second rotation shaft (not shown) which is a rotation shaft disposed on the rear side of the vehicle. In this case, in an FR (front engine and rear drive) type vehicle, the first rotation shaft corresponds to an output shaft of a transmission which is disposed on the front side of the vehicle, and to which a rotation force is transmitted from a drive source such as an engine and a motor. The second rotation shaft corresponds to an input shaft of a differential device which is disposed on the rear side, and which is configured to transmit the rotation force to rear wheels of the vehicle.

That is, the propeller shaft PS according to the present invention has a front and rear two split (divided) configuration, that is, a two piece configuration. In the propeller shaft PS, a drive shaft S1 connected to the first rotation shaft, and a driven shaft S2 connected to the second rotation shaft are connected through a third universal joint J3 which is a constant velocity joint, so as to rotate as a unit with each other around the rotation axis Z0. Besides, this propeller shaft PS is rotatably supported by a center bearing CB disposed near the third universal joint J3 which is the constant velocity joint, and suspended by a vehicle body (not shown) through a known bracket BKT.

Moreover, a front end of the propeller shaft PS (a front end of the drive shaft S1) is connected to the first rotation shaft through a first universal joint J1 which is a cardan joint. Similarly, a rear end of the propeller shaft PS (a rear end of the driven shaft S2) is connected to the second rotation shaft through a second universal joint J2 which is a cardan joint.

### Configuration of Universal Joint

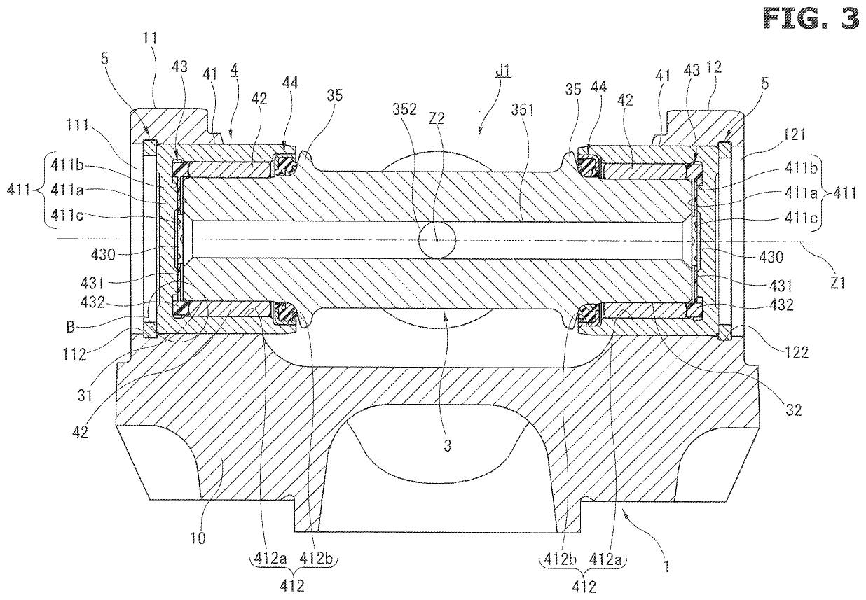

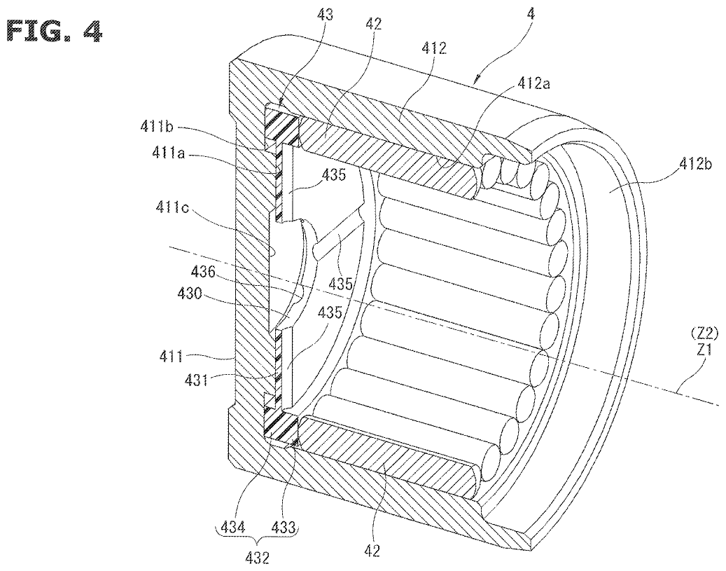

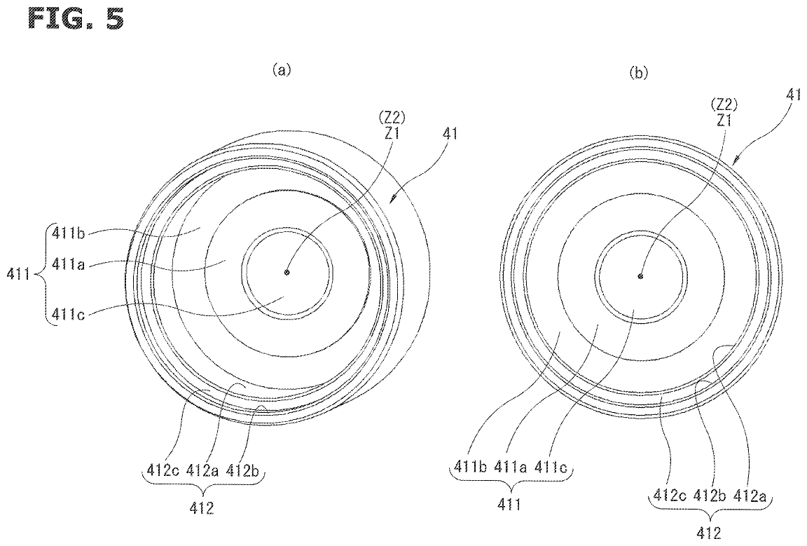

FIG. 2 is an exploded perspective view showing the first universal joint J1. FIG. 3 is a sectional view which shows the first universal joint J1, and which is taken along a line A-A of FIG. 2. FIG. 4 is a perspective sectional view showing the needle bearing 4 shown in FIG. 3. FIG. 5 are views showing the cup 41 only. FIG. 5(a) is a perspective view of the cup 41. FIG. 5(b) is a plan view of the cup 41.

As shown in FIG. 2 and FIG. 3, the first universal joint J1 includes a pair of yokes having a first yoke 1 connected to the first rotation shaft corresponding to the output shaft of the transmission (not shown), a second yoke 2 (cf. FIG. 1) connected to the drive shaft S1 of the propeller shaft PS; and a cross shaft (spider) 3 which is disposed between the first yoke 1 and the second yoke 2, and which connects the first yoke 1 and the second yoke 2 so that the first yoke 1 and the second yoke 2 are configured to be pivoted relative to each other.

The first yoke 1 includes a flange portion 10 having a substantially plate shape; and first arm portions 11 and 12 which are a pair of arm portions extending in parallel with each other from a surface of the flange portion 10 that confronts the second yoke 2, along the rotation axis Z0 of the propeller shaft PS toward the second yoke 2. Besides, the flange portion 10 and the first arm portions 11 and 12 are integrally formed, for example, by the casting.

The flange portion 10 has a substantially rectangular plate shape. The flange portion 10 includes bolt through holes 101 formed at four corners. The flange portion 10 is connected to the first rotation shaft through bolts (not shown) which penetrate through these bolt through holes 101. Besides, the planar shape of the flange portion 10 may be varied to a circular shape, a deformed shape, and so on in accordance with a connection shape of the first rotation shaft which is a counterpart, in addition to the rectangular shape exemplified in this embodiment.

The pair of the first arm portions 11 and 12 are axisymmetric with respect to the rotation axis Z2. The pair of the first arm portions 11 and 12 include a pair of first arm through holes 111 and 121 which are formed at tip end portions of the first arm portions 11 and 12, which confront each other to sandwich the rotation axis Z2, and which penetrate in the direction of the rotation axis Z1. The needle bearings 4 are inserted, respectively, from the outside into the pair of the first arm through holes 111 and 121. These needle bearings 4 pivotally support the cross shaft 3 on the first arm through holes 111 and 121.

The pair of the first arm portions 11 and 12 include annular ring retaining grooves 112 and 122 which are formed at outer end portions of the first arm through holes 111 and 121, and which have inside diameters greater than inside diameters of the first arm through holes 111 and 121, and which are continuously cut in the circumferential direction. Snap rings 5 are mounted in these ring retaining grooves 112 and 122. That is, the outer end portions of the needle bearings 4 inserted from the outside into the first arm through holes 111 and 121 are abutted on the snap rings 5 with respect to the shaft portions 31 to 34 of the cross shaft 3 inserted from the inside into the first arm through holes 111 and 121. With this, the movements of the needle bearings 4 in the axial direction (the direction of the rotation axis Z1) are restricted. That is, the detachable snap rings 5 are used as the restriction means of the axial movements of the needle bearings 4. With this, the needle bearings 4 are detachable by detaching the snap rings 5. Accordingly, it is possible to perform the maintenance such as the filling of the grease to the cross shaft 3, and the change of the needle bearings 4

Each of the pair of the first arm portions 11 and 12 includes a tool avoidance recessed portion 102 which is formed on an inner side edge portion confronting the bolt through hole 101 that is adjacent in a widthwise direction (the direction of the rotation axis Z2), which is configured to avoid an interference with a bolt tightening tool (for example, a socket wrench) for tightening a bolt (not shown) to the bolt through hole 101, and which is cut along the extension direction of the first arm portions 11 and 12. That is, the bolt through holes 101 can be disposed on a more inner side in the flange portion 10 by an amount of avoiding the interference of the first arm portions 11 and 12 with the bolt tightening tool (not shown). Accordingly, it is possible to decrease the size of the first universal joint J1.

The second yoke 2 includes a cylindrical base portion 20 connected to the drive shaft S1 of the propeller shaft PS, for example, by the friction welding; and a pair of second arm portions 21 and 22 extending in parallel with each other from a surface of the cylindrical base portion 20 which confronts the first yoke 1, along the rotation axis Z0 of the propeller shaft PS toward the first yoke 1 side (cf. FIG. 1). Besides, the pair of the second arm portions 21 and 22 are paired and operated with the pair of the first arm portions 11 and 12. The pair of the second arm portions 21 and 22 have configurations identical to those of the pair of the first arm portions 11 and 12. Accordingly, the concrete configurations refer to those of the first arm portions 11 and 12. Therefore, the detailed explanations relating to the second arm portions 21 and 22 are omitted.

The cross shaft 3 includes a first shaft portion 31 and a second shaft portion 32 which are a pair of shaft portions extending along the direction of the rotation axis Z1; and a third shaft portion 33 and a fourth shaft portion 34 which are pair of shaft portions extending along the direction of the rotation axis Z2 perpendicular to the rotation axis Z1. The cross shaft 3 is formed by integrating the first to fourth shaft portions 31 to 34 into the cross shape. Moreover, as shown in FIG. 3 and so on, the cross shaft 3 includes a first grease supply passage 351 which is opened to the insides of the needle bearings 4 supporting the first and second shaft portions 31 and 32, and which penetrates along the axial direction of the rotation axis Z1 from the first shaft portion 31 to the second shaft portion 32. Similarly, the cross shaft 3 includes a second grease supply passage 352 which is opened to the insides of the needle bearings 4 supporting the third and fourth shaft portions 33 and 34, and which penetrates along the axial direction of the rotation axis Z2 from the third shaft portion 33 to the fourth shaft portion 34. The first grease supply passage 351 and the second grease supply passage 352 are crossed and connected with each other inside the cross shaft 3.

As shown in FIG. 2 and FIG. 3, each of the needle bearings 4 includes the cup 41 having a bottomed cylindrical shape, and constituting an outer wheel; a plurality of needles 42 which are rolling members that are received in the inner circumference side of the cup 41, and that are configured to be rolled on the outer circumference surfaces of one of the shaft portions 31 to 34; a washer 43 which is disposed within a bottom portion of the cup 41, and which supports axial end portions of the needles 42 and one of the shaft portions 31 to 34 of the cross shaft 3; and a seal member 44 which is provided at an opening end portion of the cup 41, and which is configured to liquid-tightly seal between the opening end portion of the cup 41 and one of the shaft portions 31 to 34 of the cross shaft 3.

In each of these needle bearings 4, in a state in which the plurality of the needles 42, the washer 43, and the seal member 44 are received within the cup 41 (cf. FIG. 4), the each needle bearing 4 is inserted from the outside of one of the first arm through holes 111 and 121 and the second arm through holes (the through holes (not shown in FIG. 2 and FIG. 3) which are formed in the pair of the second arm portions 21 and 22 of the second yoke 2, and which pivotally support the shaft portions 33 and 34 of the cross shaft 3) into which one of the shaft portions 31 to 34 is inserted from the inside, so as to cover the one of the shaft portions 31 to 34 of the cross shaft 3. Then, a cup bottom portion 411 described later is retained by the snap ring 5 mounted from the outside of the cup bottom portion 411 in one of the ring retaining grooves 112 and 122. With this, each of the needle bearings 4 is sandwiched between one of the shaft portions 31 to 34 of the cross shaft 3 and the snap ring 5. With this, the axial movements of the needle bearings 4 are restricted.

Each of the cups 41 includes the cup bottom portion 411 having a substantially circular shape; and a cup cylindrical portion 412 having a cylindrical shape, and extending from an outer circumference edge of the cup bottom portion 411 in a direction perpendicular to the cup bottom portion 411. The cup bottom portion 411 and the cup cylindrical portion 412 are integrally made of predetermined metal material to form the cup 41. The cup bottom portion 411 includes a bottom portion general portion 411a which is formed on the inner circumference side, and which has a relatively large thickness; a bottom portion recessed portion 411b which is continuously formed along the circumferential direction on the outer circumference side of the bottom portion general portion 411a, and which receives a cup bottom portion side raised portion 434 of the washer 43 described later. The cup cylindrical portion 412 includes a cylindrical portion general portion 412a which is formed on the cup bottom portion 411 side, and which has a substantially constant inside diameter; and a seal holding portion 412b which is step wisely formed at the opening end portion of the cup cylindrical portion 412 to have an increased diameter, and which receives and holds the seal member 44.

Each of the bottom portion general portions 411a and one of the shaft portions 31 to 34 of the cross shaft 3 sandwich one of washer main body portions 431 described later, so that the bottom portion general portion 411a supports the washer main body portion 431. Moreover, the bottom portion general portion 411a includes a grease receiving portion 411c which has a recessed shape, which is formed to be recessed at a central portion of the bottom portion general portion 431a, and which is configured to receive the grease supplied from the first and second grease supply passages 351 and 352 of the cross shaft 3 through a washer through hole 430 described later. This grease receiving portion 411c has an inside diameter larger than that of the washer through hole 430. The grease receiving portion 411c is configured to introduce the grease introduced through the washer through hole 430, to second grease supply grooves 436 described later.

The needles 42 are disposed in parallel with each other in the circumferential direction on the inner circumference side of the cup cylindrical portion 412 to surround the outer circumference side of each of the shaft portions 31 to 34 of the cross shaft 3. The needles 42 are disposed and rolled between the inner circumference surface of the cup cylindrical portion 412 of the cup 41, and the outer circumference surface of each of the shaft portions 31 to 34 of the cross shaft 3. With this, it is possible to ensure the smooth pivot movements of the shaft portions 31 to 34 of the cross shaft 3 in the first arm through holes 111 and 121 and the second arm through holes (not shown).

Each of the washers 43 has a substantially circular plate shape. Each of the washers 43 is disposed between one of the shaft portions 31 to 34 of the cross shaft 3, the needles 42, and the cup bottom portion 411. Each of the washers 43 is configured to absorb a clearance and a backlash between one of the shaft portions 31 to 34 of the cross shaft 3, the needles 42, and the cup bottom portion 411. In particular, each of the washers 43 includes the washer main body portion 431 which is provided to confront one of the shaft portions 31 to 34 of the cross shaft 3, and which has a relatively small thickness; and a washer raised portion 432 which is formed on the outer circumference side of the washer main body portion 431 to confront the needles 42, and which protrudes on the both sides in the axial direction with respect to the washer main body portion 431 to have a relatively large thickness. These washer main body portion 431 and the washer raised portion 432 are integrally formed of predetermined resin material (material having a frictional coefficient smaller than that of the cup 41, for example, mixed material of nylon and glass fiber).

Each of the washer main body portions 431 has a circular plate shape having a substantially constant thickness. Each of the washer main body portions 431 has a diameter greater than that of the bottom portion general portion 411a of the cup 41. Each of the washer main body portions 431 is sandwiched between one of the shaft portions 31 to 34 of the cross shaft 3, and the bottom portion general portion 411a of the cup 41. With this, an axial clearance between each of the shaft portions 31 to 34 of the cross shaft 3, and the bottom portion general portion 411a of the cup 41 is filled. Moreover, each of the washer main body portions 431 includes the washer through hole 430 which is formed at a central portion of the washer main body portion 431 to penetrate through the washer main body portion 431 in the axial direction, and which is configured to guide the grease supplied through the first and second grease supply passages 351 and 352 of the cross shaft 3, to the cup bottom portion 411 side. The washer through hole 430 has a diameter smaller than an opening diameter of the first and second grease supply passages 351 and 352 of the cross shaft 3. With this, an entire end surface of each of the shaft portions 31 to 34 of the cross shaft 3 is configured to be abutted on one of the washer main body portions 431.

The washer raised portion 432 includes an annular needle side raised portion 433 protruding toward the needle 42 side; and an annular cup bottom portion side raised portion 434 protruding toward the cup bottom portion 411 side. The needle side raised portion 433 and the cup bottom portion side raised portion 434 are integrally formed to constitute the washer raised portion 432. The needle side raised portion 433 and the cup bottom portion side raised portion 434 are formed and protruded on the both sides of the washer main body portion 431 in the axial direction to be symmetrical with each other with respect to the washer main body portion 431. That is, the needle side raised portion 433 is abutted on the axial end portions of the needles 42. Moreover, the bottom portion side raised portion 434 is abutted on an inner bottom surface of the bottom portion recessed portion 411b of the cup 41. With these, the washer raised portion 432 is sandwiched between the needles 42 and the bottom portion recessed portion 411b of the cup 41. With this, the axial clearance between the needles 42 and the bottom portion recessed portion 411b of the cup 41 is filled.

Each of the seal members 44 is formed of predetermined rubber material into an annular shape. Each of the seal members 44 is sandwiched in the seal holding portion 412b of the cup 41 between a retaining protruding portion 35 which has a flange shape, and which is formed into an annular shape at a base end portion of one of the shaft portions 31 to 34 of the cross shaft 3, and a stepped portion 412c formed in a boundary between the seal holding portion 412b and the cylindrical portion general portion 412a. With this, each of the seal members 44 is elastically abutted on the outer circumference surface of one of the shaft portions 31 to 34 of the cross shaft 3, and the inner circumference surface of the seal holding portion 412b.

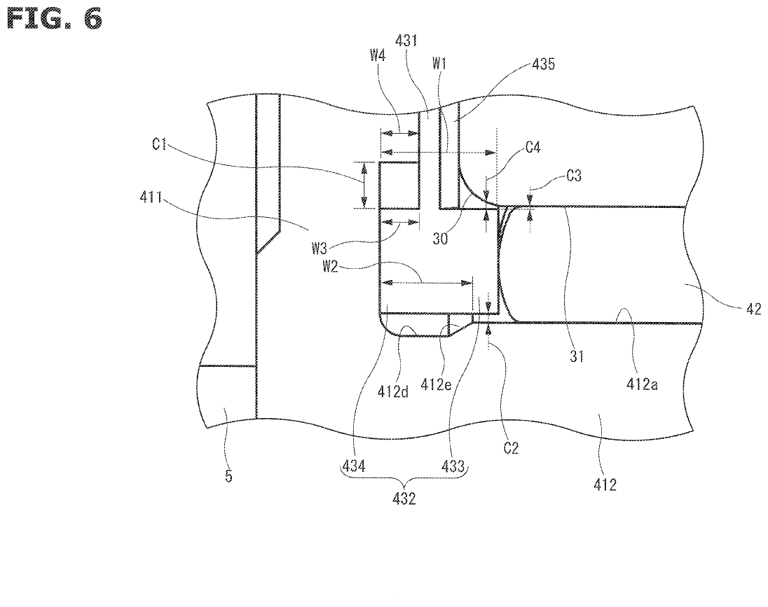

FIG. 6 is a partially enlarged view showing the needle bearing 4 by enlarging a B portion of FIG. 3.

As shown in FIG. 6, the cup 41 includes a cylindrical portion recessed portion 412d which is continuously formed in the circumferential direction at an end portion of the cylindrical portion 412 on the cup bottom portion 411 side, and which is recessed in the radially outward direction. The cylindrical recessed portion 412d has an axial width W2 smaller than an axial width W1 of the washer raised portion 432. By this size relationship, the needle side raised portion 433 of the washer raised portion 432 confronts the cylindrical portion general portion 412a. The needle side raised portion 433 and the cylindrical portion general portion 412a are overlapped with each other in the axial direction. That is, a connection portion 412e between the cylindrical portion recessed portion 412d and the cylindrical portion general portion 412a is positioned on the cup bottom portion 411 side of a tip end of the needle side raised portion 433 in the axial direction. Besides, the connection portion 412e between the cylindrical portion recessed portion 412d and the cylindrical portion general portion 412a has a conical tapered shape having diameters gradually decreased from the cylindrical portion recessed portion 412d side toward the cylindrical portion general portion 412a side. The cylindrical portion recessed portion 412d and the cylindrical portion general portion 412a are smoothly connected by this conical tapered shape.

Moreover, the bottom portion recessed portion 411b of the cup 41 has an inside diameter smaller than an inside diameter of the cup bottom portion side raised portion 434 of the washer 43. More specifically, the bottom portion recessed portion 411b has the inside diameter so that a first clearance C1 formed radially between the inner circumference surface of the bottom portion recessed portion 411b, and the inner circumference surface of the cup bottom portion side raised portion 434 is greater than a second clearance C2 formed radially between the inner circumference surface of the cylindrical portion general portion 412a of the cup cylindrical portion 412, and the outer circumference surface of the needle side raised portion 433 of the washer 43.

Moreover, the bottom portion recessed portion 411b of the cup 41 has a depth W4 greater than a protruding amount W3 of the cup bottom portion side raised portion 434 of the washer 43. The bottom portion recessed portion 411b is largely recessed relative to the protruding amount of the cup bottom portion side raised portion 434. With this, the washer main body portion 431 can appropriately abutted (seated) on the bottom portion general portion 411a irrespective of a manufacturing error and so on of the protruding amount of the cup bottom portion side raised portion 434.

Each of the needles 42 is a needle roller having a rod shape having a constant outside diameter. Each of the needles 42 includes an axial end surface which confronts the washer 43, and which has an arc shape raised toward the washer 43 side. That is, each of the needles 42 is brought into a line contact with the end surface of the needle side raised portion 433 of the washer 43. With this, the frictional resistance with the washer 43 is decreased at the rolling movement of the each needle 42.

In the washer 43, the washer main body portion 431 has a diameter greater than the outside diameter of one of the shaft portions 31 to 34 of the cross shaft 3. Moreover, in the washer 43, the washer raised portion 432 has a radial width smaller than the diameter of the needle 42. By this size relationship, the needle side raised portion 433 has the predetermined clearance (the second clearance C2) formed radially between the needle side raised portion 433 and the cylindrical portion general portion 412a of the cup 41, and a predetermined clearance (third clearance C3) formed radially between the needle side raised portion 433, and one of the shaft portions 31 to 34 of the cross shaft 3.

Moreover, in the washer 43, the washer raised portion 432 (the needle side raised portion 433) has an inside diameter greater than the outside diameter of one of the shaft portions 31 to 34 of the cross shaft 3. With this, a predetermined clearance C4 is formed radially between the needle side raised portion 433 and one of the shaft portions 31 to 34 of the cross shaft 3. Besides, each of the shaft portions 31 to 34 of the cross shaft 3 includes a chamfering portion 30 which has a substantially arc section, that is, an R chamfering (round chamfering) shape, and which is located at an outer circumference edge of a tip end portion of the each of the shaft portions 31 to 34. The needle side raised portion 433 is overlapped with the chamfering portion 30 in the axial direction. The predetermined clearance C4 is formed between the needle side raised portion 433 and the chamfering portion 30.

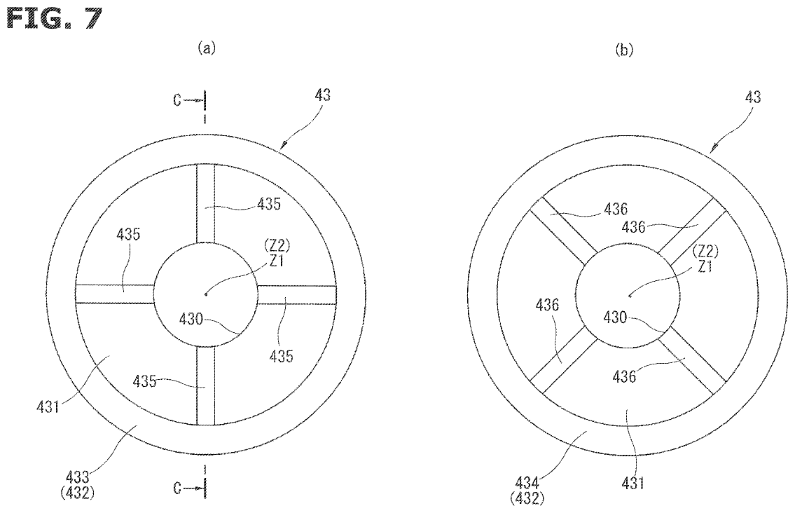

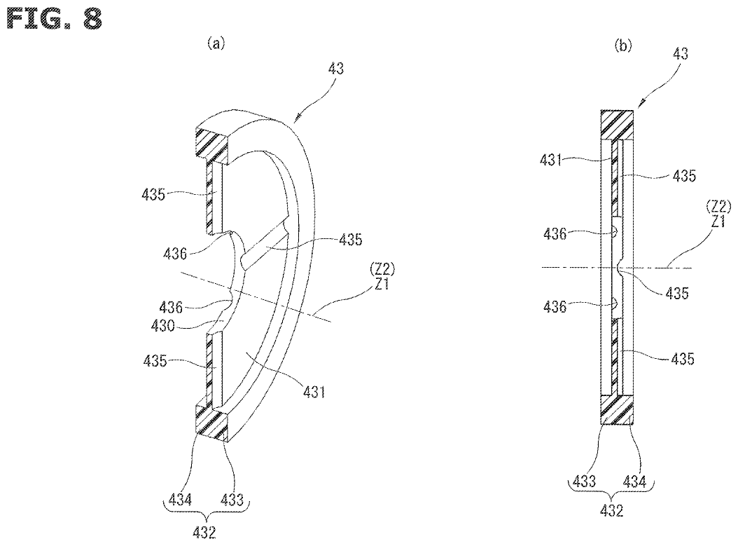

FIG. 7 are views showing the washer 43 only. FIG. 7(a) shows a plan view of the washer 43. FIG. 7(b) shows a back view of the washer 43. Moreover, FIG. 8(a) is a perspective sectional view taken along a line C-C of FIG. 7(a). FIG. 8(b) is a sectional view taken along the line C-C of FIG. 7(a).

As shown in FIG. 7 and FIG. 8, the washer 43 includes the washer main body portion 431 formed into a circular plate shape having a relatively small thickness; and the washer raised portion 432 which is formed on the outer circumference side of the washer main body portion 431, and which protrudes on both sides of the washer main body portion 431 in the axial direction. The washer main body portion 431 and the washer raised portion 432 are integrally formed. The washer raised portion 432 includes the needle side raised portion 433 protruding toward the needle 42 side; and the cup bottom portion side raised portion 434 protruding toward the cup bottom portion 411 side. The needle side raised portion 433 and the cup bottom portion side raised portion 434 are formed to protrude on the both sides of the washer main body portion 431 in the axial direction to be symmetrical with respect to the washer main body portion 431.

Furthermore, the washer main body portion 431 includes the circular washer through hole 430 which is formed at the central portion of the washer main body portion 431, and which penetrates through the washer main body portion 431. The washer main body portion 431 includes first grease supply grooves 435 and second grease supply grooves 436 which are a plurality of grease supply grooves that are formed on both side surfaces of the washer main body portion 431, that extend in the radial directions from the washer through hole 430, and that linearly extend in the radial directions. That is, in the washer main body portion 431, the first grease supply grooves 435 are formed and opened on the surface of the washer main body portion 431 which confronts one of the shaft portions 31 to 34 of the cross shaft 3. The second grease supply grooves 436 are formed and opened on the surface of the washer main body portion 431 which confronts the cup bottom portion 411.

Each of the first grease supply grooves 435 and the second grease supply grooves 436 has a recessed arc cross section. The first grease supply grooves 435 are four grooves formed at an interval of 90 degrees in the circumferential direction. The second grease supply grooves 436 are four grooves formed at an interval of 90 degrees in the circumferential direction. With this, connection passages are formed between the cup bottom portion 411 (the bottom portion general portion 411a), and one of the shaft portions 31 to 34 of the cross shaft 3 which is abutted on the washer main body portion 431, so as to connect the washer through hole 430 and the needle 42 side. With this, the grease supplied from the shaft portions 31 to 34 of the cross shaft 3 to the washer through hole 430 is supplied, respectively, through the first and second grease supply grooves 435 and 436 to the needles 42 side which is positioned on the radially outer side.

Moreover, the first grease supply grooves 435 and the second grease supply grooves 436 are alternately formed when viewed from the axial directions of the shaft portions 31 to 34 of the cross shaft 3. That is, the first grease supply grooves 435 and the second grease supply grooves 436 are disposed so that phases of the first grease supply grooves 435 and the second grease supply grooves 436 are displaced (shifted) by 45 degrees in the circumferential direction so as not to be overlapped with each other in the axial direction (cf. FIGS. 7(a) and (b)).

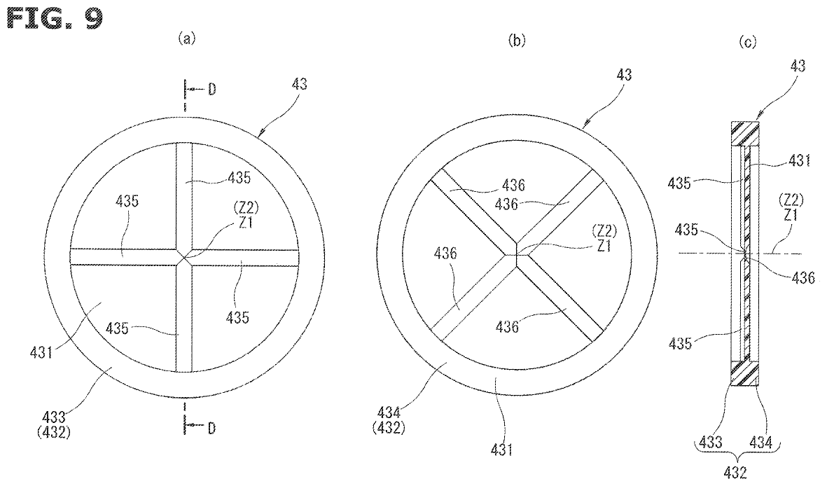

FIG. 9 show another example of the washer shown in FIG. 7. FIG. 9(a) is a plan view of the washer. FIG. 9(b) is a back view of the washer. FIG. 9(c) is a sectional view taken along a line D-D of FIG. 9(a).

In this embodiment, the washer 43 has the washer through hole 430 formed at the central portion as shown in FIG. 7. However, the washer through hole 430 is not an essential configuration. For example, the washer main body portion 431 may have a closing configuration as shown in FIG. 9. That is, it is possible to vary provision or no provision of the washer through hole 430 of the washer 43 in accordance with the cost, the specification of the needle bearing 4 to which the washer 43 is applied, and so on.

### Operations and Effects of this Embodiment

In the conventional universal joint, the washer of the needle bearing has a two split shape (two divided shape). Accordingly, the assembling operation of the needle bearing is complicated. Moreover, the assembling workability of the needle bearing is deteriorated. Furthermore, the manufacturing cost of the universal joint is increased due to this deterioration of the assembling workability of the needle bearing. Therefore, there is a room for the improvement.

On the other hand, in the first universal joint J1 according to this embodiment, it is possible to attain the following effects, and thereby to dissolve the problems of the conventional universal joint.

The universal joint J1 connected to the rotation shaft (the first rotation shaft (not shown)) provided to the vehicle, the universal joint including:
the yoke (the first yoke 1) including;
   the yoke main body portion (the flange portion 10),
   the pair of the arm portions (the first arm portions 11 and 12) which are formed from the yoke main body portion (the flange portion 10) into a bifurcated shape, and which extend in the rotation axis Z0 direction of the rotation shaft, and
   the arm through holes (the first arm through holes 111 and 121) each of which is formed in one of the confronting surfaces of the pair of the arm portions (the first arm portions 11 and 12) that confront each other to sandwich the rotation axis Z0, and each of which penetrates through the one of the confronting surfaces of the pair of the arm portions (the first arm portions 11 and 12),
the cups 41 each of which is received within one of the arm through holes (the first arm through holes 111 and 121), each of the cups 41 including;
   the cup bottom portion 411, and
   the cup cylindrical portion 412 extending from the outer circumference edge of the cup bottom portion 411 in the direction perpendicular to the cup bottom portion 411,
the cross shaft 3 which is integrally formed to have the cross shape, which is inserted into the inner circumference sides of the cup cylindrical portions 412, and which includes the pair of the cylindrical shaft portions 31 to 34 each of which is inserted in the inner circumference side of one of the cup cylindrical portions 412,
the plurality of the needles 42 each of which is received within the inner circumference side of one of the cup cylindrical portions 412, and each of which is disposed between the inner circumference surface of the one of the cup cylindrical portions 412, and the outer circumference surface of one of the shaft portions 31 to 34;
the washers 43 each including;
   the washer main body portion 431 which has the circular plate shape, and which is disposed between one of the cup bottom portions 411 and one of the shaft portions 31 to 34,
   the needle side raised portion 433 which has the annular shape, which is integrally formed on the outer circumference side of one of the washer main body portions 431, and which protrudes toward the needle 42 side, and
   the cup bottom portion side raised portion 434 which has an annular shape, which is integrally formed on the outer circumference side of the one of the washer main body portions 431, and which protrudes toward one of the cup bottom portion 411 side.

In this way, in this embodiment, the washer main body portion 431 and the washer raised portion 432 (the needle side raised portion 433 and the cup bottom portion side raised portion 434) are integrally formed to constitute the washer 43. With this, it is possible to handle the washer 43 as one component, and thereby to improve the assembling workability of the washer 43 with respect to the needle bearing 4. Consequently, it is possible to decrease the manufacturing cost of the first universal joint J1 pivotally supporting the cross shaft 3 by the needle bearing 4.

Moreover, in this embodiment, each of the needle side raised portions 432 and one of the cup bottom portion side raised portions 434 are formed into a symmetrical shape in an axial direction in which one of the shaft portions 31 to 34 extends, to sandwich one of the washer main body portions 431.

Even when the washer main body portion 431 and the washer raised portion 432 (the needle side raised portion 433 and the cup bottom portion side raised portion 434) are integrally formed as described above, the front and back are erroneously assembled at the assembling operation of the washer 43 in a case in which the front and back (the inside and outside) of the washer 43 are determined.

On the other hand, in this embodiment, the needle side raised portion 433 and the cup bottom portion side raised portion 434 are symmetrically formed with respect to the washer main body portion 431. Accordingly, there are no front and back (the inside and outside) of the washer 43. Therefore, it is possible to suppress the erroneous assembly of the washer 43.

Moreover, in this embodiment, each of the cup bottom portions 411 includes a bottom portion general portion 411a provided on a central portion side, and a bottom portion recessed portion 411b which is formed and recessed on an inner side surface of the bottom portion general portion 411a that confronts one of the shaft portions 31 to 34, on the outer circumference side of the bottom portion general portion 411a, and which receives one of the cup bottom portion side raised portions 434.

In this way, in this embodiment, the bottom portion general portion 411a and the bottom portion recessed portion 411b which have different heights (different axial widths) are provided on the inner side surface of the cup bottom portion 411. The washer main body portion 431 is abutted on the bottom portion general portion 411a. The washer raised portion 432 (the needle side raised portion 433 and the cup bottom portion side raised portion 434) are abutted on the bottom portion recessed portion 411b. With these, the washer 43 constituted by the washer main body portion 431 and the washer raised portion 432 (the needle side raised portion 433 and the cup bottom portion side raised portion 434) which have the different thicknesses (the different axial widths) are appropriately received within the cup bottom portion 433.

Moreover, in this embodiment, the bottom portion recessed portion 411b is largely recessed in the direction in which one of the shaft portion 31 to 34 extends, relative to a protruding amount of one of the cup bottom portion side raised portions 434.

In this way, in this embodiment, the depth W4 of the bottom portion recessed portion 411b is greater than the protruding amount W3 of the cup bottom portion side raised portion 434. With this, it is possible to appropriately seat the washer main body portion 431 on the bottom portion general portion 411a. With this, it is possible to improve the stability of the washer 43 within the needle bearing 4 (the cup 41).

Moreover, in this embodiment, the first clearance C1 is formed between each of the cup bottom portion side raised portions 434 and one of the bottom portion general portions 411a in a radial direction perpendicular to one of the shaft portions 31 to 34. The second clearance C2 is formed between each of the needle side raised portions 433 and one of the cup cylindrical portions 412 (the cylindrical portion general portion 412a) in the radial direction. The first clearance C1 is greater than the second clearance C2.

In this way, in this embodiment, the first clearance C1 formed radially between the bottom portion side raised portion 434 and the bottom portion general portion 411a is set to be greater than the second clearance C2 formed radially between the needle side raised portion 433 and the cup cylindrical portion 412 (the cylindrical portion general portion 412a). By this size relationship, there is no risk of the interference of the cup bottom portion side raised portion 434 with the bottom portion general portion 411a when the washer 43 is assembled to the cup 41. Accordingly, it is possible to improve the assembling operation of the washer 43 to the cup 41.

Moreover, in this embodiment, each of the cup cylindrical portions 412 includes the cylindrical portion general portion 412a abutted on the plurality of the needles 42, and the cylindrical portion recessed portion 412d which is provided on the cup bottom portion 411 side of the cylindrical portion general portion 412a, and which is recessed on the outside in the radial direction perpendicular to one of the shaft portions 31 to 34.

In this way, in this embodiment, the cup cylindrical portion 412 includes the cylindrical portion recessed portion 412d on the cup bottom portion 411 side. With this, by the cylindrical portion recessed portion 412d, it is possible to suppress the interference with tools (not shown) for the grinding of the cylindrical portion general portion 412a. Moreover, it is possible to improve the grinding operation of the cylindrical portion general portion 412a.

Moreover, in this embodiment, the connection portion 412e between each of the cylindrical portion general portions 412a and one of the cylindrical portion recessed portions 412d is provided on the cup bottom portion 411 side of the tip end of one of the needle side raised portions 433 in the axial direction in which one of the shaft portions 31 to 34 extends.

In this way, in this embodiment, the connection portion 412e between the cylindrical portion general portion 412a and the cylindrical portion recessed portion 412d is provided on the cup bottom portion 411 side of the tip end of the needle side raised portion 433. With this, the connection portion 412e between the cylindrical portion general portion 412a and the cylindrical portion recessed portion 412d confronts the washer 43 in the radial direction. With this, there is no risk of the interference of the angular portion of the connection portion 412e between the cylindrical portion general portion 412a and the cylindrical portion recessed portion 412d with the needles 42. Accordingly, in the needles 42, it is unnecessary to provide an avoidance processing for avoiding the interference with the connection portion 412e between the cylindrical portion general portion 412a and the cylindrical portion recessed portion 412d. Consequently, it is possible to attain the improvement of the productivity and the decrease of the cost of the needle bearing 4 and the first universal joint J1.

Moreover, in this embodiment, each of the shaft portions 31 to 34 includes the grease supply passage (the first and second grease supply passages 351 and 352) which is formed within the each shaft portion 31 to 34, which is opened on the tip end of the each shaft portion 31 to 34, and which is configured to supply the grease to the needle 42 side. The washer main body portion 431 includes the grease supply groove (the first and second grease supply grooves 435 and 436) which is formed on the surface abutted on one of the shaft portions 31 to 34, or the surface abutted on the cup bottom portion 411, and which extends in the radial direction perpendicular to the one of the shaft portions 31 to 34.

In this way, in this embodiment, each of the shaft portions 31 to 34 of the cross shaft 3 includes the first and second grease supply passages 351 and 352 which are formed within the each shaft portion 31 to 34. Moreover, the first grease supply grooves 435 or the second grease supply grooves 436 are formed on the surface of each of the washers 43 which confronts one of the shaft portions 31 to 34, or the cup bottom portion 411. With this, it is possible to supply the grease which is the lubricant, to the needles 42 disposed on the outer circumference sides of the shaft portions 31 to 34, through the first and second grease supply passages 351 and 352, and the first grease supply grooves 435 or the second grease supply grooves 436. Accordingly, it is possible to attain the favorable lubrication of the needles 42.

Moreover, in this embodiment, each of the grease supply grooves includes the first grease supply groove 435 that is formed on a surface which is an inner side surface of one of the washer main body portions 431, and which is abutted on one of the shaft portions 31 to 34, and the second grease supply groove 436 that is formed on the surface which is an outer side surface the one of the washer main body portions 431, and which is abutted on the cup bottom portion 411. The first grease supply groove 435 and the second grease supply groove 436 are alternately formed when viewed from the axial direction in which one of the shaft portions 31 to 34 extend.

In a case in which the first grease supply grooves 435 and the second grease supply grooves 436 are overlapped with each other, the thickness of the washer main body portion 431 in the overlapping portion between the grease supply grooves 435 and 436 becomes extremely small. Accordingly, in this embodiment, the first grease supply grooves 435 and the second grease supply grooves 436 are disposed so that the phases of the first grease supply grooves 435 and the second grease supply grooves 436 are displaced (shifted) each other so as not to be overlapped with each other. With this, it is possible to ensure the rigidity of the washer main body portion 431, and to suppress the damage of the washer 43, and the decrease of the durability of the washer 43.

Moreover, in this embodiment, each of the washer main body portions 431 includes the washer through hole 430 that penetrates in the axial direction in which one of the shaft portions extends, and that confronts the grease supply groove (the first and second grease supply grooves 435 and 436).

In this way, in this embodiment, the washer main body portion 431 includes the washer through hole 430 connected (opened) to the first and second grease supply grooves 435 and 436. With this, it is possible to supply the grease supplied through the first and second grease supply passages 351 and 352 of the shaft portions 31 to 34 of the cross shaft 3, through the washer through hole 430 to the back surface (the surface confronting the cup bottom portion 411) of the washer 43. Accordingly, it is possible to lubricate the back surface of the washer 43.

Moreover, in this embodiment, each of the washers 43 is made of resin material having a frictional coefficient smaller than a frictional coefficient of one of the cups 41.

In this way, the washer 43 is made of the resin material having the frictional coefficient smaller than that of the cup 41. With this, it is possible to decrease the friction with the end surfaces 31 to 34 of the cross shaft 3 relative to a case in which the washer 43 is not used. Moreover, it is possible to attain the smooth pivot movement of the cross shaft 3 in the first universal joint J1.

Moreover, in this embodiment, the inside diameter of each of the needle side raised portions 433 is greater than the outside diameter of one of the shaft portions 31 to 34 in the radial direction perpendicular to the one of the shaft portions 31 to 34.

In this way, the inside diameter of the needle side raised portion 433 of the washer 43 is greater than the outside diameter of the shaft portions 31 to 34 of the cross shaft 3. With this, it is possible to suppress the interference of the shaft portions 31 to 34 with respect to the needle side raised portion 433 when each of the shaft portions 31 to 34 is inserted into the inner circumference side of the needle side raised portion 433. With this, it is possible to improve the assembling workability of the needle bearing 4 with respect to the cross shaft 3, and to improve the productivity of the first universal joint J1.

### Variation of First Embodiment

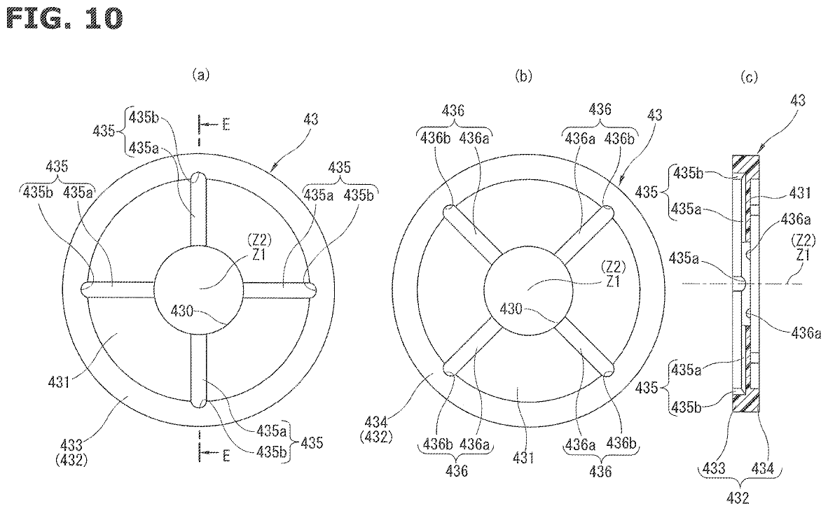

FIG. 10 are views showing a universal joint according to a variation of the first embodiment of the present invention. FIG. 10(a) is a plan view of the washer 43. FIG. 10(b) is a back view of the washer 43. FIG. 10(c) is a sectional view taken along a line E-E of FIG. 10(a).

As shown in FIG. 10, in this embodiment, the first and second grease supply grooves 435 and 436 extend to be overlapped with the needle side raised portion 433 and the cup bottom portion raised portion 434 in the radial directions. That is, in this embodiment, the first and second grease supply grooves 435 and 436 are continuously provided over (among) the washer main body portion 431, the needle side raised portion 433, and the cup bottom portion side raised portion 434. The first and second grease supply grooves 435 and 436 penetrate from the washer through hole 430 to the needle 42 side which is the outer circumference side of the shaft portions 31 to 34 of the cross shaft 3.

Specifically, the first and second grease supply grooves 435 and 436 include first and second radial grooves 435a and 436a which are radially formed and opened on the side surfaces of the washer main body portion 431; and the first and second axial grooves 435b and 436b axially formed and opened on the inner circumference surfaces of the needle side raised portion 433 and the cup bottom portion side raised portion 434. By this configuration, the grease introduced through the washer through hole 430 to the first and second grease supply grooves 435 and 436 is directly introduced through the first and second radial grooves 435a and 436a and the first and second axial grooves 435b and 436b, to the outer circumference sides of the shaft portions 31 to 34 of the cross shaft 3, that is, to the needle 42 side.

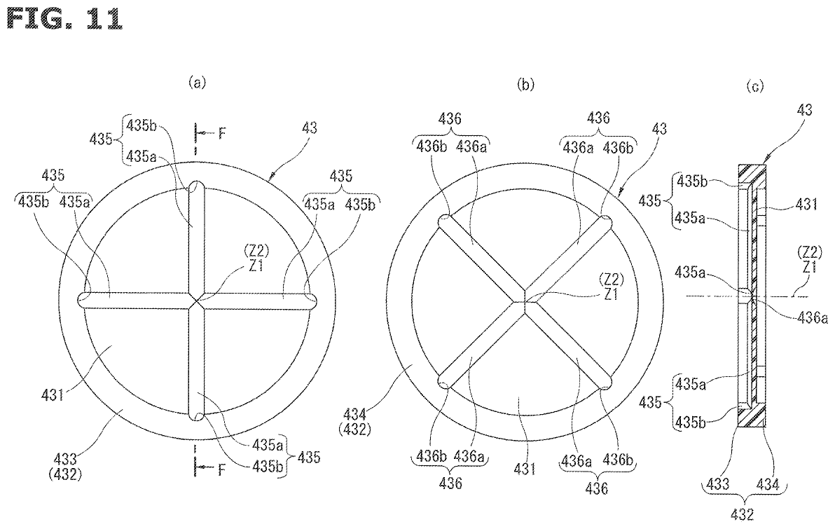

FIG. 11 show another example of the washer 43 shown in FIG. 10. FIG. 11(a) is a plan view of the washer 43. FIG. 11(b) is a back view of the washer 43. FIG. 11(c) is a sectional view taken along a line F-F of FIG. 11(a).

In the above variation, the washer 43 includes the washer through hole 430 formed at the central portion as shown in FIG. 10. However, the washer through hole 430 is not the essential configuration, similarly to the first embodiment. For example, the washer main body portion 431 may have a closing configuration as shown in FIG. 11.

As described above, in this embodiment, in the first universal joint J1, the grease supply grooves (the first and second grease supply grooves 435 and 436) are provided to be overlapped with the needle side raised portion 433 or the cup bottom portion side raised portion 434 in the radial directions.

In this way, in this embodiment, the first and second grease supply grooves 435 and 436 are continuously provided over the washer main body portion 431, the needle side raised portion 433, and the cup bottom portion side raised portion 434 to penetrate from the washer through hole 430 to the needle 42 side. With this, the grease introduced through the washer through hole 430 is directly introduced through the first and second grease supply grooves 435 and 436 (the first and second radial grooves 435a and 436a and the first and second axial grooves 435b and 436b) to the needle 42 side. Accordingly, it is possible to more effectively lubricate the needles 42.

### Second Embodiment

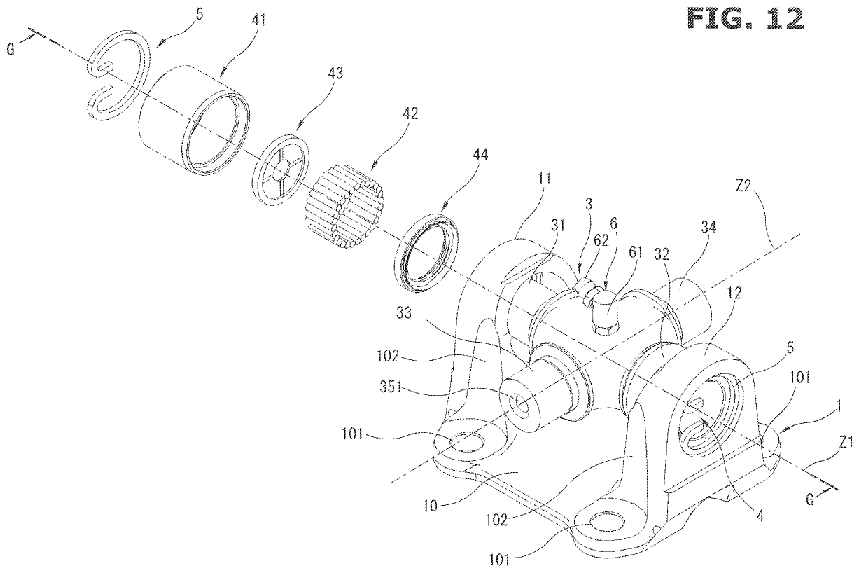

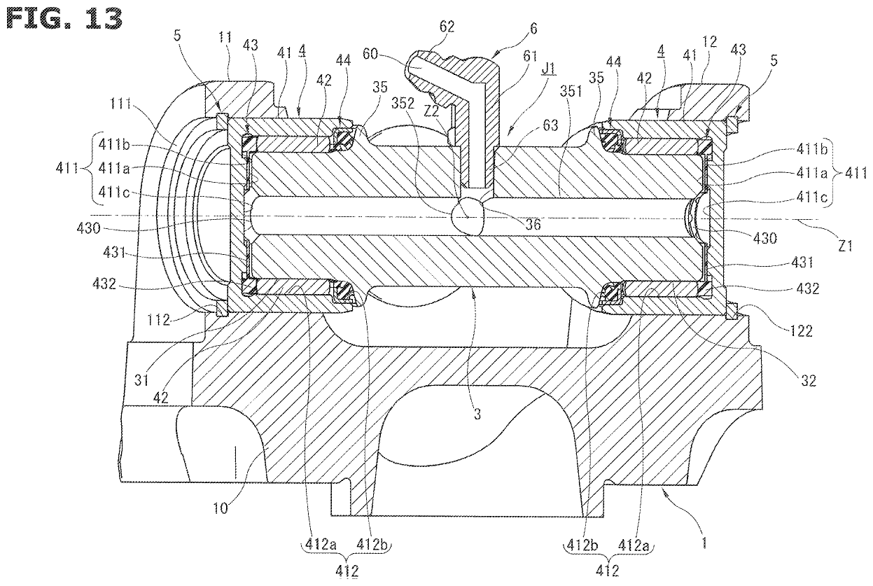

FIG. 12 and FIG. 13 show a universal joint and a propeller shaft according to a second embodiment of the present invention. In the second embodiment, a configuration of the cross shaft 3 in the first universal joint J1 according to the first embodiment is varied. Besides, basic configurations other than the above variation are identical to those of the first embodiment. Accordingly, the configurations identical to those of the first embodiment have the identical symbols. The explanations thereof are omitted.

FIG. 12 is an enlarged perspective view showing the first universal joint according to the second embodiment of the present invention. FIG. 13 is a sectional view taken along a line G-G of FIG. 13.

As shown in FIG. 12 and FIG. 13, the first universal joint J1 according to this embodiment includes a cross shaft through hole 36 that is formed at a central portion of the cross shaft 3 at a position at which the first grease supply passage 351 and the second grease supply passage 352 are crossed, that is configured to connect the first and second grease supply passages 351 and 352 and the outside, and that is formed and opened on a vertically upper side along a direction perpendicular to the rotation axes Z1 and Z2. This cross shaft through hole 36 includes an internal screw portion. A nipple 6 is screwed in this internal screw portion. The nipple 6 is configured to function for the injection of the grease into the first and second grease supply passages 351 and 352.

The nipple 6 includes a nipple base portion 61 extending linearly; a grease introduction portion 62 extending from the nipple base portion 61 in an obliquely upward direction; and a nipple mounting portion 63 which is formed at a lower end portion of the nipple base portion 61, which has a stepped diameter decreasing shape, and which includes an external screw portion engaged with the internal screw portion of the cross shaft through hole 36. The nipple base portion 61, the grease introduction portion 62, and the nipple mounting portion 63 are integrally formed of predetermined metal material (for example, aluminum) to constitute the nipple 6. The nipple 6 includes a continuous nipple inside passage 60 which is formed within the nipple 6, and which penetrates from the grease introduction portion 62 to the nipple mounting portion 63. By this configuration, the nipple 6 is configured to introduce the grease injected through the grease introduction portion 62, through the nipple inside passage 60 to the first and second grease supply passages 351 and 352.

As described above, in this embodiment, the nipple 6 is mounted in the cross shaft through hole 36 formed to penetrate through the cross shaft 3, unlike the first embodiment in which the cross shaft 3 is closed. With this, it is possible to additionally inject the grease through the nipple 6. Accordingly, even when the needle bearing 4 is mounted in the shaft portions 31 to 34 of the cross shaft 3, it is possible to add the grease without detaching the needle bearing 4 in a case in which the grease is decreased due to the consumption by the long time use. Consequently, it is possible to improve the maintenance characteristic of the first universal joint.

The present invention is not limited to the configurations and the aspects exemplified in the embodiments. The present invention may be freely varied in accordance with the specification, the cost and so on of the applied object as long as it is possible to attain the above-described operations and effects of the present invention.

For example, the following aspects are conceivable as the universal joint according to the above-described embodiments.

That is, a universal joint according to one aspect, A universal joint connected to a rotation shaft provided to a vehicle, the universal joint includes: a yoke including; a yoke main body portion, a pair of arm portions which are formed from the yoke main body portion into a bifurcated shape, and which extend in a rotation axis direction of the rotation shaft, and arm through holes each of which is formed in one of confronting surfaces of the pair of the arm portions that confront each other to sandwich the rotation axis, and each of which penetrates through the one of the confronting surfaces of the pair of the arm portions, cups each of which is received within one of the arm through holes, each of the cups including; a cup bottom portion, and a cup cylindrical portion extending from an outer circumference edge of the cup bottom portion in a direction perpendicular to the cup bottom portion, a cross shaft which is integrally formed to have a cross shape, which is inserted into inner circumference sides of the cup cylindrical portions, and which includes a pair of cylindrical shaft portions each of which is inserted in the inner circumference side of one of the cup cylindrical portions; a plurality of needles each of which is received within the inner circumference side of one of the cup cylindrical portions, and each of which is disposed between an inner circumference surface of the one of the cup cylindrical portions, and an outer circumference surface of one of the shaft portions; washers each including; a washer main body portion which has a circular plate shape, and which is disposed between one of the cup bottom portions, and one of the shaft portions, a needle side raised portion which has an annular shape, which is integrally formed on an outer circumference side of one of the washer main body portion, and which protrudes toward the needle side, and a cup bottom portion side raised portion which has an annular shape, which is integrally formed on the outer circumference side of the one of the washer main body portions, and which protrudes toward the cup bottom portion side.

In a universal joint according to a preferable aspect, each of the needle side raised portions and one of the cup bottom portion side raised portions are formed into a symmetrical shape in an axial direction in which one of the shaft portions extends, to sandwich one of the washer main body portions.

In a universal joint according to another preferable aspect, each of the cup bottom portions includes a bottom portion general portion provided on a central portion side, and a bottom portion recessed portion which is formed and recessed on an inner side surface of the bottom portion general portion that confronts one of the shaft portions, on the outer circumference side of the bottom portion general portion, and which receives one of the cup bottom portion side raised portions.

In a universal joint according to still another preferable aspect, the bottom portion recessed portion is largely recessed in the axial direction in which one of the shaft portions extends, relative to a protruding amount of one of the cup bottom portion side raised portions.

In a universal joint according to still another preferable aspect, a first clearance is formed between each of the cup bottom portion side raised portions and one of the bottom portion general portions in a radial direction perpendicular to one of the shaft portions; a second clearance is formed between each of the needle side raised portions and one of the cup cylindrical portions in the radial direction; and the first clearance is larger than the second clearance.

In a universal joint according to still another preferable aspect, each of the cup cylindrical portions includes a cylindrical portion general portion abutted on the plurality of the needles, and a cylindrical portion recessed portion which is provided on the cup bottom portion side of the cylindrical portion general portion, and which is recessed on the outside in a radial direction perpendicular to one of the shaft portions.

In a universal joint according to still another preferable aspect, a connection portion between each of the cylindrical portion general portions and one of the cylindrical portion recessed portions is provided on the cup bottom portion side of a tip end of one of the needle side raised portions in the axial direction in which one of the shaft portions extends.

In a universal joint according to still another preferable aspect, each of the shaft portions includes a grease supply passage which is formed within the each shaft portion, which is opened on a tip end of the each shaft portion, and which is configured to supply a grease to the needle side; and the washer main body portion includes a grease supply groove which is formed on a surface abutted on one of the shaft portions, or a surface abutted on the cup bottom portion, and which extends in a radial direction perpendicular to the one of the shaft portions.

In a universal joint according to still another preferable aspect, each of the grease supply grooves is provided at a position at which the each grease supply groove is overlapped with one of the needle side raised portions or one of the cup bottom portion side raised portions in the radial direction.

In a universal joint according to still another preferable aspect, each of the grease supply grooves includes a first grease supply groove that is formed on a surface which is an inner side surface of one of the washer main body portions, and which is abutted on one of the shaft portions, and a second grease supply groove that is formed on a surface which is an outer side surface of the one of the washer main body portions, and which is abutted on the cup bottom portion; and the first grease supply groove and the second grease supply groove are alternately formed when viewed from the axial direction in which the one of the shaft portions extends.

In a universal joint according to still another preferable aspect, each of the washer main body portions includes a washer through hole that penetrates in the axial direction in which one of the shaft portions extends, and that confronts the grease supply groove.

In a universal joint according to still another preferable aspect, each of the washers is made of resin material having a frictional coefficient smaller than a frictional coefficient of one of the cups.

In a universal joint according to still another preferable aspect, an inside diameter of each of the needle side raised portions is greater than an outside diameter of one of the shaft portions in a radial direction perpendicular to the one of the shaft portions.

Moreover, for example, the following aspects are conceivable as the propeller shaft according to the above-described embodiments.

That is, a propeller shaft connected to a rotation shaft provided to a vehicle, the propeller shaft includes: a shaft portion connected to the rotation shaft, and configured to serve for a power transmission of the rotation shaft; an universal joint connecting the shaft portion and the rotation shaft; the universal joint including; a yoke including; a yoke main body portion connected to the shaft portion, a pair of arm portions which are formed from the yoke main body portion into a bifurcated shape, and which extend in a rotation axis of the rotation shaft, and arm through holes each of which is formed on one of confronting surfaces of the pair of the arm portions that confront each other to sandwich the rotation axis, and each of which penetrates through the one of the confronting surfaces of the pair of the arm portions, cups each of which is received within one of the arm through holes, each of the cups including; a cup bottom portion, and a cup cylindrical portion extending from an outer circumference edge of the cup bottom portion in a direction perpendicular to the cup bottom portion, a cross shaft which is integrally formed to have a cross shape, which is inserted into inner circumference sides of the cup cylindrical portions, and which includes a pair of cylindrical shaft portions each of which is inserted in the inner circumference side of one of the cup cylindrical portions; a plurality of needles each of which is received within the inner circumference side of one of the cup cylindrical portions, and each of which is disposed between an inner circumference surface of the one of the cup cylindrical portions, and an outer circumference surface of one of the shaft portions; washers each including; a washer main body portion which has a circular plate shape, and which is disposed between one of the cup bottom portions, and one of the shaft portions, a needle side raised portion which has an annular shape, which is integrally formed on an outer circumference side of one of the washer main body portion, and which protrudes toward the needle side, and a cup bottom portion side raised portion which has an annular shape, which is integrally formed on the outer circumference side of the one of the washer main body portions, and which protrudes toward the cup bottom portion side.

1. A universal joint connected to a rotation shaft provided to a vehicle, the universal joint comprising:
a yoke including;
a yoke main body portion,
a pair of arm portions which are formed from the yoke main body portion into a bifurcated shape, and which extend in a rotation axis direction of the rotation shaft, and
arm through holes each of which is formed in one of confronting surfaces of the pair of the arm portions that confront each other to sandwich the rotation axis, and each of which penetrates through the one of the confronting surfaces of the pair of the arm portions,
cups each of which is received within one of the arm through holes, each of the cups including;
a cup bottom portion, and
a cup cylindrical portion extending from an outer circumference edge of the cup bottom portion in a direction perpendicular to the cup bottom portion,
a cross shaft which is integrally formed to have a cross shape, which is inserted into inner circumference sides of the cup cylindrical portions, and which includes a pair of cylindrical shaft portions each of which is inserted in the inner circumference side of one of the cup cylindrical portions;
a plurality of needles each of which is received within the inner circumference side of one of the cup cylindrical portions, and each of which is disposed between an inner circumference surface of the one of the cup cylindrical portions, and an outer circumference surface of one of the shaft portions;
washers each including;
a washer main body portion which has a circular plate shape, and which is disposed between one of the cup bottom portions, and one of the shaft portions,
a needle side raised portion which has an annular shape, which is integrally formed on an outer circumference side of one of the washer main body portion, and which protrudes toward the needle side, and
a cup bottom portion side raised portion which has an annular shape, which is integrally formed on the outer circumference side of the one of the washer main body portions, and which protrudes toward the cup bottom portion side.

2. The universal joint as claimed in claim 1, wherein each of the needle side raised portions and one of the cup bottom portion side raised portions are formed into a symmetrical shape in an axial direction in which one of the shaft portions extends, to sandwich one of the washer main body portions.

3. The universal joint as claimed in claim 1, wherein each of the cup bottom portions includes a bottom portion general portion provided on a central portion side, and a bottom portion recessed portion which is formed and recessed on an inner side surface of the bottom portion general portion that confronts one of the shaft portions, on the outer circumference side of the bottom portion general portion, and which receives one of the cup bottom portion side raised portions.

4. The universal joint as claimed in claim 3, wherein the bottom portion recessed portion is largely recessed in the axial direction in which one of the shaft portions extends, relative to a protruding amount of one of the cup bottom portion side raised portions.

5. The universal joint as claimed in claim 3, wherein a first clearance is formed between each of the cup bottom portion side raised portions and one of the bottom portion general portions in a radial direction perpendicular to one of the shaft portions; a second clearance is formed between each of the needle side raised portions and one of the cup cylindrical portions in the radial direction; and the first clearance is larger than the second clearance.

6. The universal joint as claimed in claim 1, wherein each of the cup cylindrical portions includes a cylindrical portion general portion abutted on the plurality of the needles, and a cylindrical portion recessed portion which is provided on the cup bottom portion side of the cylindrical portion general portion, and which is recessed on the outside in a radial direction perpendicular to one of the shaft portions.

7. The universal joint as claimed in claim 6, wherein a connection portion between each of the cylindrical portion general portions and one of the cylindrical portion recessed portions is provided on the cup bottom portion side of a tip end of one of the needle side raised portions in the axial direction in which one of the shaft portions extends.

8. The universal joint as claimed in claim 1, wherein each of the shaft portions includes a grease supply passage which is formed within the each shaft portion, which is opened on a tip end of the each shaft portion, and which is configured to supply a grease to the needle side; and the washer main body portion includes a grease supply groove which is formed on a surface abutted on one of the shaft portions, or a surface abutted on the cup bottom portion, and which extends in a radial direction perpendicular to the one of the shaft portions.

9. The universal joint as claimed in claim 8, wherein each of the grease supply grooves is provided at a position at which the each grease supply groove is overlapped with one of the needle side raised portions or one of the cup bottom portion side raised portions in the radial direction.

10. The universal joint as claimed in claim 8, wherein each of the grease supply grooves includes a first grease supply groove that is formed on a surface which is an inner side surface of one of the washer main body portions, and which is abutted on one of the shaft portions, and a second grease supply groove that is formed on a surface which is an outer side surface of the one of the washer main body portions, and which is abutted on the cup bottom portion; and the first grease supply groove and the second grease supply groove are alternately formed when viewed from the axial direction in which the one of the shaft portions extends.

11. The universal joint as claimed in claim 8, wherein each of the washer main body portions includes a washer through hole that penetrates in the axial direction in which one of the shaft portions extends, and that confronts the grease supply groove.

12. The universal joint as claimed in claim 1, wherein each of the washers is made of resin material having a frictional coefficient smaller than a frictional coefficient of one of the cups.

13. The universal joint as claimed in claim 1, wherein an inside diameter of each of the needle side raised portions is greater than an outside diameter of one of the shaft portions in a radial direction perpendicular to the one of the shaft portions.

14. A propeller shaft connected to a rotation shaft provided to a vehicle, the propeller shaft comprising:
a shaft portion connected to the rotation shaft, and configured to serve for a power transmission of the rotation shaft;
an universal joint connecting the shaft portion and the rotation shaft;
the universal joint including;
a yoke including;
a yoke main body portion connected to the shaft portion,
a pair of arm portions which are formed from the yoke main body portion into a bifurcated shape, and which extend in a rotation axis of the rotation shaft, and
arm through holes each of which is formed on one of confronting surfaces of the pair of the arm portions that confront each other to sandwich the rotation axis, and each of which penetrates through the one of the confronting surfaces of the pair of the arm portions,
cups each of which is received within one of the arm through holes, each of the cups including;
a cup bottom portion, and
a cup cylindrical portion extending from an outer circumference edge of the cup bottom portion in a direction perpendicular to the cup bottom portion,
a cross shaft which is integrally formed to have a cross shape, which is inserted into inner circumference sides of the cup cylindrical portions, and which includes a pair of cylindrical shaft portions each of which is inserted in the inner circumference side of one of the cup cylindrical portions;
a plurality of needles each of which is received within the inner circumference side of one of the cup cylindrical portions, and each of which is disposed between an inner circumference surface of the one of the cup cylindrical portions, and an outer circumference surface of one of the shaft portions;
washers each including;
a washer main body portion which has a circular plate shape, and which is disposed between one of the cup bottom portions, and one of the shaft portions,
a needle side raised portion which has an annular shape, which is integrally formed on an outer circumference side of one of the washer main body portion, and which protrudes toward the needle side, and
a cup bottom portion side raised portion which has an annular shape, which is integrally formed on the outer circumference side of the one of the washer main body portions, and which protrudes toward the cup bottom portion side.
